(19) United States
(12) Patent Application Publication
(10) Pub. No.: US 2011/0108572 A1
(43) Pub. Date: May 12, 2011

(54) FLEXIBLE POUCH WITH SELECTIVELY ATTACHABLE FITMENT ASSEMBLY

(76) Inventor: R. Charles Murray, Sarasota, FL (US)

(21) Appl. No.: 12/941,715

(22) Filed: Nov. 8, 2010

Related U.S. Application Data
(60) Provisional application No. 61/258,941, filed on Nov. 6, 2009.

(51) Int. Cl. B67D 1/00; B65D 47/00

(52) U.S. Cl. 222/83; 222/548

(57) ABSTRACT

A selectively disposable fitment assembly for use with a flexible pouch is provided. The fitment assembly is mounted to a selected portion of an outer surface of the flexible pouch. The fitment assembly includes a cap having a spacer, a base, and a tube spout. The base includes an adhesive coating operable to stick the base onto the selected outer surface of the pouch. The tube spout includes a first passageway. The base includes an aperture contiguous with the first passageway. The cap is configured to fittingly engage the outer surface of the tube spout and is rotatable with respect to the tube spout. The cap includes an elongated piercing member. Once the fitment assembly is mounted onto the pouch, the cap may be then rotated onto the base until the piercing members puncture the pouch so as to create an opening through which product may flow.

### CROSS-REFERENCE TO RELATED APPLICATIONS

This Application claims the benefit of U.S. Provisional Application 61/258,941 filed on Nov. 6, 2009, the contents of which are incorporated herein by reference in its entirety.

### FIELD OF THE INVENTION

The present invention relates generally to a selectively positioned fitment assembly having a base with an adhesive coating for attaching the fitment assembly onto a pouch, a tube spout, and a piercing member operable to puncture a hole in the pouch where the fitment assembly is attached.

### BACKGROUND OF THE INVENTION

Flexible pouches are currently known and used in the art and include a tube spout fitment for accessing the contents of the pouch. Such pouches come in various sizes and shapes. The tube spout fitment is predisposed onto the body of the pouch so as to facilitate access of the pouch depending upon the intended use of the pouch. For instance, in self-standing pouches it may be desirable to have the tube spout fitment positioned near the bottom of the pouch so as to allow gravity to assist in the delivery of the contents. In other cases it may be desirable to have the tube spout fitment disposed at the top. For instance, in cases where the pouch body is generally easily manipulated by a hand, it may be desirable to have the tube spout fitment at the top so as to simulate drinking from a cup. However, users may prefer to have the tube spout fitment on other places, and thus it remains desirable to have a flexible pouch with a tube spout fitment which may be attached onto the pouch based on the desires of the user.

### SUMMARY OF THE INVENTION

A selectively attachable fitment assembly for use with a flexible pouch is provided. The flexible pouch may be formed from a sheet of flexible material which is folded onto itself and sealed so as to form a pouch body. The fitment assembly is mounted to a selected portion of an outer surface of the flexible pouch.

The fitment assembly includes a cap having a spacer, a base, and a tube spout. The fitment assembly may be mounted onto a desired location of the outer surface of the flexible pouch so as to optimize the use of the pouch based upon the user's preferences.

The base is a generally planer member having an adhesive coating operable to stick the base onto the selected portion of the outer surface of the pouch. The fitment assembly may further include a seal which protects the adhesive coating prior to installation onto the pouch body.

The tube spout may be integrally formed onto the base. The tube spout includes a first passageway. The base includes an aperture contiguous with the first passageway. The tube spout includes an outer wall surface. The outer wall surface may be threaded so as to threadingly engage the inner wall surface of the cap. The spacer is mounted between the base and the cap.

The cap is configured to fittingly engage the outer surface of the tube spout. The cap includes an outer peripheral edge defining a cap opening. The inner wall surface of the cap may be threaded.

The cap includes an elongated piercing member. The elongated piercing member is generally cylindrical and includes an end portion adapted to pierce the pouch body. A portion of the elongated piercing member extends beyond the peripheral edge of the cap. Specifically, the piercing member extends beyond the outer peripheral edge of the opening of the cap, but remains behind the outer surface of the base. Thus, the end of the piercing member is spaced apart from the outer surface of the pouch when the fitment assembly is initially mounted onto the pouch. The configuration of the piercing member allows for placement of the fitment assembly onto the pouch body without penetration of the pouch body.

In operation the fitment assembly may be mounted onto any location of the outer surface of the pouch body selected by the user. To do so, the seal is simply removed from the base so as to reveal the adhesive coating. The fitment assembly can be applied to the desired location of the pouch.

Once the fitment assembly is mounted onto the pouch, the user may simply remove the spacer from the fitment assembly. The base the outer surface of the base is threaded so as to be in threaded communication with the inner surface wall of the cap. The cap may be then rotated onto the base until the piercing members puncture the pouch so as to create an opening through which product may flow.

In the second preferred embodiment, the fitment assembly the tube spout is rotatably mounted to the base. The tube spout is a generally elongated cylindrical member. The first passageway extends along the length of the tube spout. The tube spout further includes a port in communication with the first passageway. The port is disposed on a side of the tube spout and extends generally orthogonal from the outer surface of the tube spout.

The fitment assembly of the second preferred embodiment further includes a tap. The tap has a tap body. The tap body is generally cylindrical and includes a second passageway. The tap body is rotatably mounted within the first passageway of the tube spout. The tap body further includes a bore for allowing fluids to pass. The tap body is rotated so as to place the bore in fluid communication of the port of the tube spout.

The elongated piercing member is disposed on distal edge of the port. The outer surface of the port may be threaded. The threads are configured to engage the threaded inner surface wall of the base. The elongated piercing member has a first portion and a second portion. Each portion is generally ramp-shaped, and the second portion is larger than the first portion. As with the first preferred embodiment, the base may include an adhesive surface for selectively mounting the tap onto the pouch body.

The tap may further include a security device. The security device includes a stop plate and a pair of arms extending outwardly from the stop plate. The arms are configured to engage the base. The security device is disposed between the tap body and the base. Specifically, the anus engage the base and the stop plate is pushed onto the base so as to position the top edge of the stop plate underneath the handle. Thus, the security device is operable to prevent the tap from being turned.

In operation, the security device is removed from the tap, and the seal is removed from the base. The base is placed firmly onto a desired location of the pouch so as to place the adhesive coating into contact with the pouch body, wherein the fitment assembly is fixedly mounted thereto.

The tube spout is rotated about the base. As the tube spout is rotated, the port is displaced further into the base so as to push the piercing member axially into the pouch. The piercing member engages the pouch and creates an opening in the pouch.

The user may then rotate the handle so as to place the bore into fluid communication with the port thereby placing the fitment assembly into the open position. It should be appreciated that the bore, first passageway and second passageway are in fluid communication with each other. Thus fluid from the pouch is accessible and may flow out through the opening of the tap. Stopping fluids may simply be done by rotating the handle so as to displace the bore from fluid communication with the port.

### BRIEF DESCRIPTION OF THE DRAWINGS

A better understanding of the present invention will be had upon reference to the following detailed description when read in conjunction with the accompanying drawings wherein like reference characters refer to like parts throughout the several views and in which:

FIG. 1 is a perspective view of an illustration of a first preferred embodiment of the flexible pouch with the selectively disposable fitment assembly mounted on the front of the pouch;

FIG. 2 is an exploded view of the fitment assembly, and a view of the fitment assembly mounted to the bottom of the pouch;

FIG. 3 is an exploded view of the fitment assembly shown in FIGS. 1 and 2;

FIG. 4 is a cross-sectional view of the fitment assembly showing the spacer positioning the piercing member away from the pouch body;

FIG. 5 is a cross-sectional view of the fitment assembly with the spacer removed and the elongated piercing member penetrating the pouch body;

FIG. 6 is a perspective view of a second preferred embodiment of the cap;

FIG. 7 is a perspective view of the second preferred embodiment of the fitment assembly;

FIG. 8 is a perspective view of the second preferred embodiment of the fitment assembly mounted onto the pouch;

FIG. 9 is a perspective view of FIG. 8 showing the security device removed;

FIG. 10 is an exploded view of the fitment assembly of the second preferred embodiment;

FIG. 11 is a cross-sectional view of the fitment assembly mounted onto a pouch, the tap is in the closed position; and

FIG. 12 is a cross-sectional view of the fitment assembly mounted onto a pouch wherein the piercing member has punctured a hole in the pouch and the tap is in the open position.

### DETAILED DESCRIPTION OF THE INVENTION

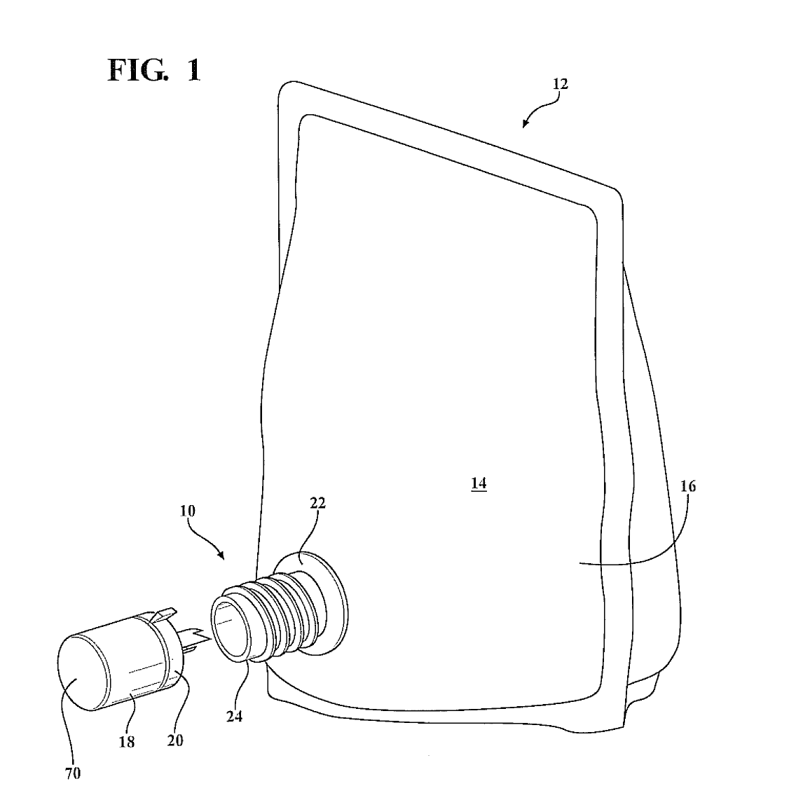

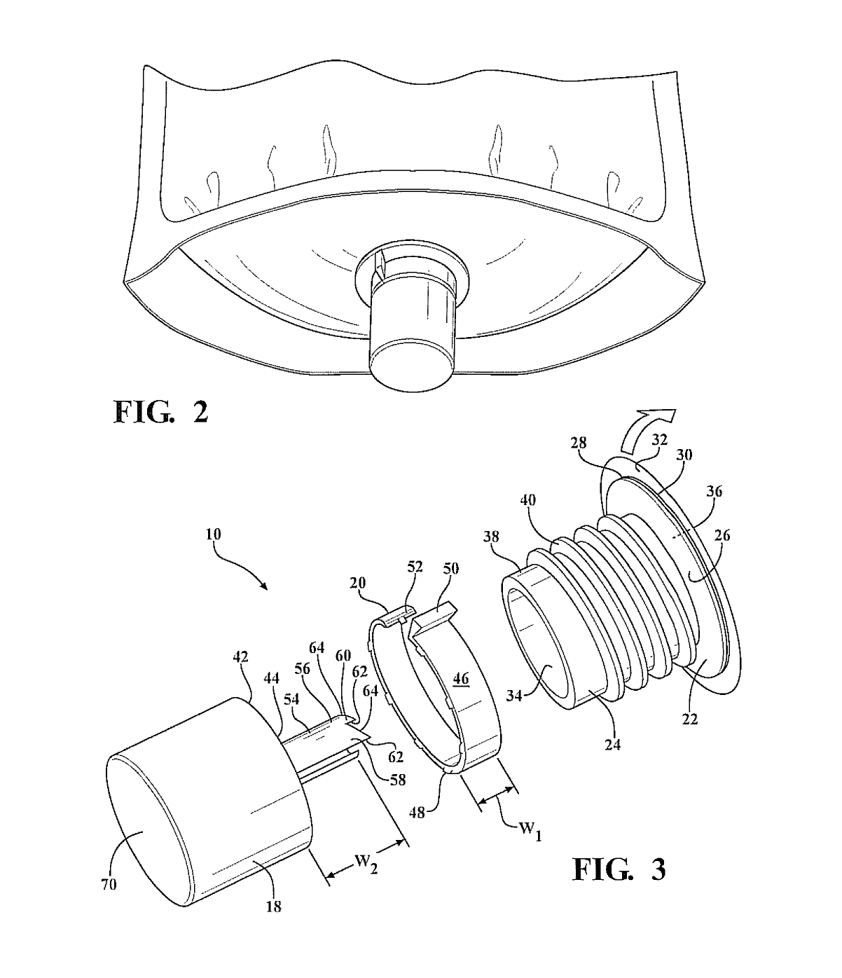

With reference now to FIGS. 1 and 2, a selectively attachable fitment assembly 10 for use with a flexible pouch 12 is provided. The flexible pouch 12 may be formed from a sheet 14 of flexible material which is folded onto itself and sealed so as to form a pouch body 16. Alternatively, the pouch body 16 may be formed from two symmetrical sheets 14 of pliable material and sealed together. Other features such as a gusseted bottom (not shown) may be added to the pouch 12. Additionally the sides of the pouch 12 may also be gusseted, as shown in FIG. 1, so as to facilitate the introduction of the pouch 12 contents, such as liquids, therein. Many types of flexible pouches 12 are currently known and used in the art, and any of these flexible pouches 12 are adaptable for use herein, including flexible pouches 12 containing drinks, paint, and the like.

With reference again to FIGS. 1 and 2, the selectively attachable fitment assembly 10 is mounted to an outer surface of the flexible pouch 12. The fitment assembly 10 may be mounted to any portion of the outer surface of the pouch body 16. For instance, FIG. 1 shows the fitment assembly 10 mounted to the front side of the pouch body 16, whereas FIG. 2 shows the fitment assembly 10 mounted to the bottom of the pouch body 16.

With reference now to FIG. 3, an exploded view of a first preferred embodiment of the fitment assembly 10 is provided. The fitment assembly 10 includes a cap 18 having a spacer 20, a base 22, and a tube spout 24. The fitment assembly 10 may be mounted onto a desired location of the outer surface of the flexible pouch 12 so as to optimize the use of the pouch 12 based upon the user's preferences.

The base 22 is a generally planer member having a first surface 26 opposite a second surface 28. An adhesive coating 30 may be applied to the second surface 28 of the base 22. A seal 32 is mounted onto the adhesive coating 30. The seal 32 protects the adhesive coating 30 prior to installation onto the pouch body 16. The seal 32 is a flexible sheet 14 having a slick nonstick surface that may be applied to the second surface 28. The seal 32 may be removed so as expose the adhesive coating 30 for contact onto the pouch body 16, as indicated by the arrow.

The tube spout 24 may be integrally formed onto the base 22. The tube spout 24 includes a first passageway 34. The base 22 includes an aperture 36 contiguous with the first passageway 34. The tube spout 24 includes an outer wall surface 38. The outer wall surface 38 may be threaded 40 so as to threadingly engage the inner wall surface of the cap 18. The spacer 20 is mounted between the first surface 26 of the base 22 and the cap 18.

Preferably the cap 18 is molded out of a polypropylene, such as plastic, or a polypropylene resin. The cap 18 is configured to fittingly engage the outer surface of the tube spout 24. The cap 18 includes an outer peripheral edge 42 defining a cap opening 44. The inner wall surface of the cap 18 may also be threaded 40.

The spacer 20 may be molded from the same material as the cap 18. The spacer 20 is disposed between the cap 18 and the base 22. More specifically, the spacer 20 is attached to the outer peripheral edge 42 of the cap 18. The spacer 20 includes a generally elongated member 46 bounding an area symmetrical to the opening of the cap 18. The elongated member 46 has a width of a first predetermined length designated by W₁. Preferably the spacer 20 includes a plurality of thin walled tabs 48. Some of the thin walled tabs 48 extend from the outer edge of the elongated member 46 to the outer peripheral edge 42 of the cap 18. The remaining thin walled tabs 48 extend from the outer edge of the spacer 20 to the base 22. The thin walled tabs 48 may be severed so as to separate the spacer 20 from the cap 18 and the base 22. Thus, in addition to holding the fitment assembly 10 together as a unit, the thin walled tabs 48 also provide evidence of tampering.

The spacer 20 may further include a pull tab 50 and a line of weakening 52. The pull tab 50 may be integrally formed to a portion of the elongated member 46. The line of weakening 52 is formed between opposite ends of the elongated member 46. The line of weakening 52 interconnects one end of the elongated member 46 to the opposite end of the elongated member 46. Preferably, the pull tab 50 is disposed adjacent the line of weakening 52.

The cap 18 includes an elongated piercing member 54. The elongated piercing member 54 is generally cylindrical and includes an end portion 56 adapted to pierce the pouch body 16. A portion of the elongated piercing member 54 extends beyond the peripheral edge of the cap 18.

With reference again to FIG. 3, the first preferred embodiment of the elongated piercing member 54 is provided. In the first preferred embodiment, the end portion 56 of the elongated piercing member 54 includes a first piercing member 58 and a second piercing member 60. The first and second piercing members 58, 60 each have a walled surface 62 and an angled surface 64 so as to form a shape commonly described as a ramp. The walled surfaces 62 are spaced apart from each other. The walled surface 62 of the second piercing member 60, also referenced as a trailing piercing member 60, is longer than the walled surface 62 of the first piercing member 58, also referenced herein as the leading piercing member 58.

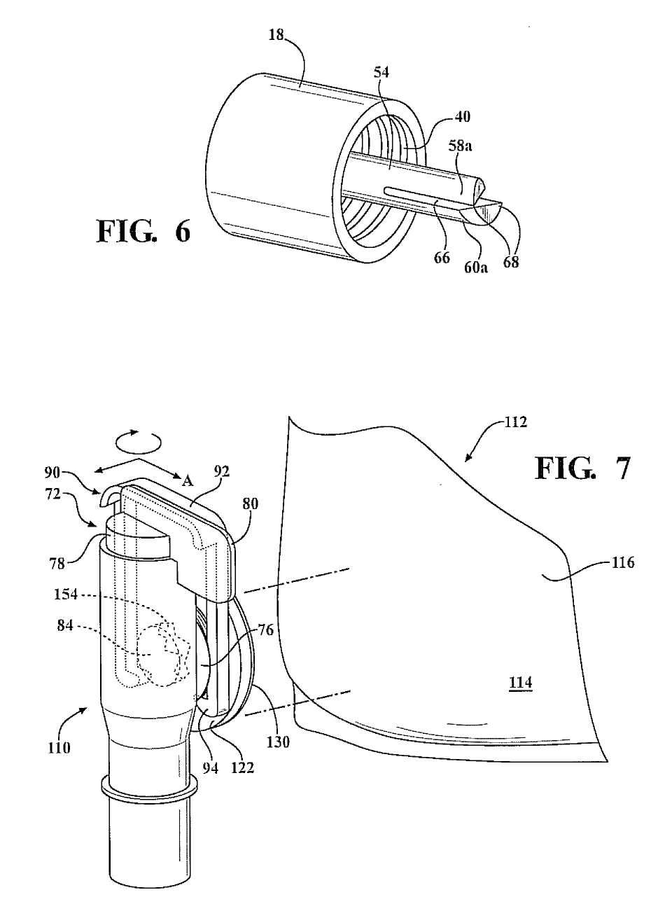

With reference now to FIG. 6, a second preferred embodiment of the cap 18 is provided. In the second preferred embodiment of the elongated piercing member 54, the first and second piercing members 58a, 60a are generally symmetrical to each other. The first piercing member 58a is spaced apart the second piercing member 60a. The first and second piercing members 58a, 60a have an elongated body. The first and second piercing members 58a, 60 extend outwardly from the distal end of the elongated piercing member 54 similar to tines on a fork. The first and second piercing members 58a, 60a each have a slanted edge 66 so as to form a piercing surface 68. The slanted edges 66 extend beyond the peripheral edge of the cap 18. The first piercing member 58a is generally longer than the second piercing member 60a.

A portion of elongated piercing member 54 extends beyond the outer peripheral edge 42 of the opening of the cap 18, but remains behind the outer edge of the spacer 20 such that the end of the piercing member is spaced apart from the first surface 26 of the base 22 when the fitment assembly 10 is completely assembled. Thus, placement of the fitment assembly 10 onto the pouch body 16 will not penetrate the pouch body 16.

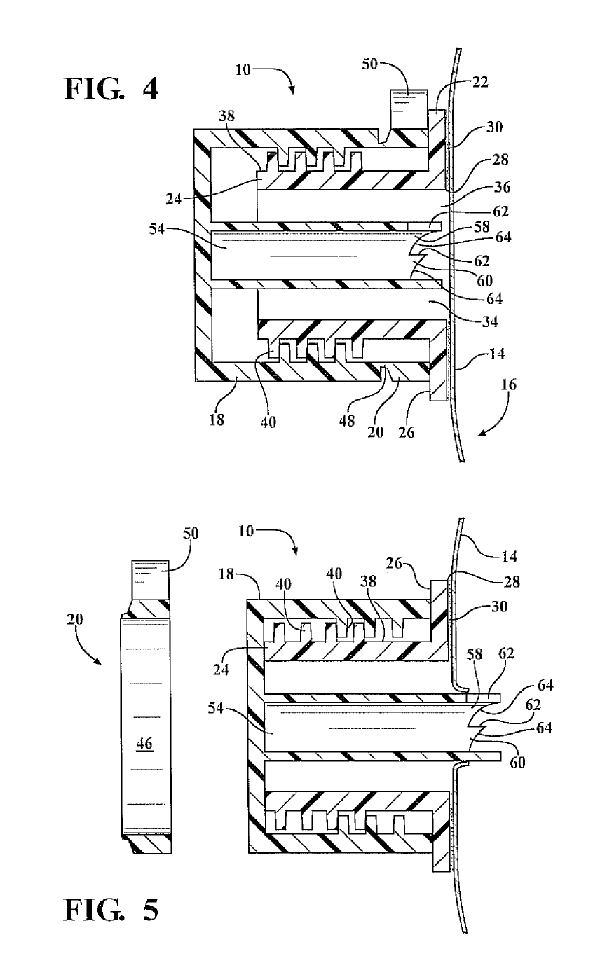

With reference now to FIGS. 4 and 5, an operation of the fitment assembly 10 is provided. In operation the fitment assembly 10 may be mounted onto any location of the outer surface of the pouch body 16 selected by the user. To do so, the seal 32 is simply removed from the base 22 so as to reveal the adhesive coating 30. The fitment assembly 10 can be applied to the desired location as shown in FIG. 4.

Once the fitment assembly 10 is applied, the user may simply pull on the tab so as to remove the spacer 20 from the fitment assembly 10. The cap 18 is rotated onto the tube spout 24, wherein the first and second piercing members 58, 60 are displaced axially within the first passageway 34 of the tube spout 24. The cap 18 is rotated until the first and second piercing members 58, 60 puncture the pouch 12 so as to create an opening through which product may flow as shown in FIG. 5. It should be appreciated that the leading piercing member 58 creates an initial hole in the pouch 12 which is further expanded by the larger trailing piercing member 60.

It should be appreciated that the fitment assembly 10 may be made of a hardened polymer or metal. The figures illustratively show that the cap 18 has an end wall 70. However, it should be appreciated that the cap 18 may include a tap 72 with a valve operable to close and open access to the contents of the pouch 12, as shown in FIGS. 6-7.

The flexible pouch 12 may come with a carrier 74 attached to the pouch body 16. The carrier 74 is a container adapted to hold the fitment assembly 10. For instance, the carrier 74 may be a pouch 12 taped onto the pouch body 16. The pouch 12 may be opened so as to access the fitment assembly 10. The user simply removes the fitment assembly 10 from the pouch 12 and selectively places the fitment assembly 10 onto a portion of the pouch 12.

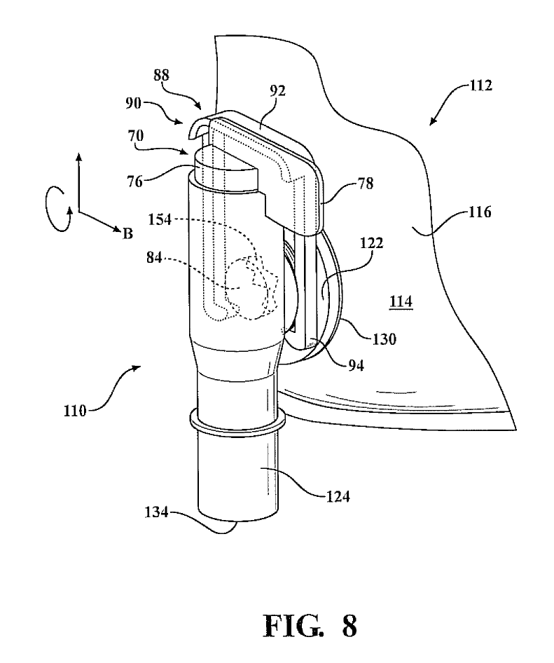

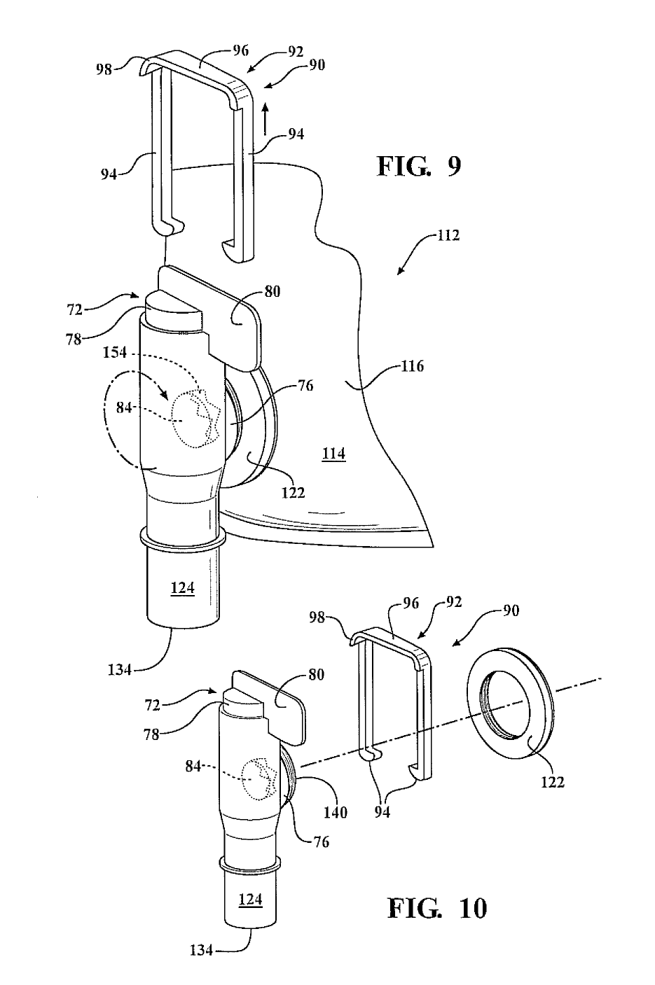

With reference now to FIGS. 7-11, an illustration of the second preferred embodiment of the fitment assembly 110 is provided, wherein like parts are indicated by numerals offset by 100. In the second preferred embodiment of the fitment assembly 110, the tube spout 124 is rotatably mounted to the base 122. The tube spout 124 is a generally elongated cylindrical member. The first passageway 134 extends along the length of the tube spout 124. The tube spout 124 further includes a port 76 in communication with the first passageway 134. The port 76 is disposed on the side of the tube spout 124 and extends generally orthogonal from the outer surface of the tube spout 124.

The fitment assembly 110 of the second preferred embodiment further includes a tap 72. The tap 72 has a tap body 78 and a handle 80 fixedly mounted to the tap body 78. The tap body 78 is generally cylindrical and includes a second passageway 82. The tap body 78 is rotatably mounted within the first passageway 134 of the tube spout 124. The tap body 78 is a cylindrical member having a bore 84 for allowing fluids to pass. The bore 84 may be rotated so as to be in fluid communication of the port 76 of the tube spout 124.

The elongated piercing member 154 is disposed on distal edge of the port 176. The outer surface of the port 76 is threaded 140 and is configured to engage the threaded inner surface wall of the base 122. The elongated piercing member 154 has a first portion 86 and a second portion 88. Both the first and second portions 86, 88 are generally ramp-shaped, and the second portion 88 is larger than the first portion 86.

As with the first preferred embodiment, the base 122 may include an adhesive coating 130 for selectively mounting the tap 72 onto the pouch body 116. Preferably the adhesive coating 130 is covered with seal 132, such as a sheet of material so as to preserve the integrity of the adhesive coating 130 for application onto the pouch body 116.

The first and second portions 86, 88 of the elongated piercing member 54 extend generally orthogonal from the tube spout 124. The first portion 86 may extend further away from the tube spout 124 than the second portion 88. When assembled, the elongated piercing member 154 is housed within the base 122.

The fitment assembly 110 of the second preferred embodiment may further include a security device 90. The security device 90 includes a stop plate 92 and a pair of arms 94 extending outwardly from the stop plate 92. The stop plate 92 has a side wall 96 that is angled. Thus the stop plate 92 narrows in width from one end to the other. The side wall 96 has a top edge 98. The arms 94 are configured to engage the base 122. The security device 90 is disposed between the tap body 78 and the base 122. The stop plate 92 is firmly pushed against the base 122 so as to place the side wall 96 into contact with the tap body 78 and the top edge 98 in contact with the handle 80. The security device 90 is operable to prevent the tap 72 from being turned. The security device 90 may be a plastic member extending between the tap 72 and the base 122.

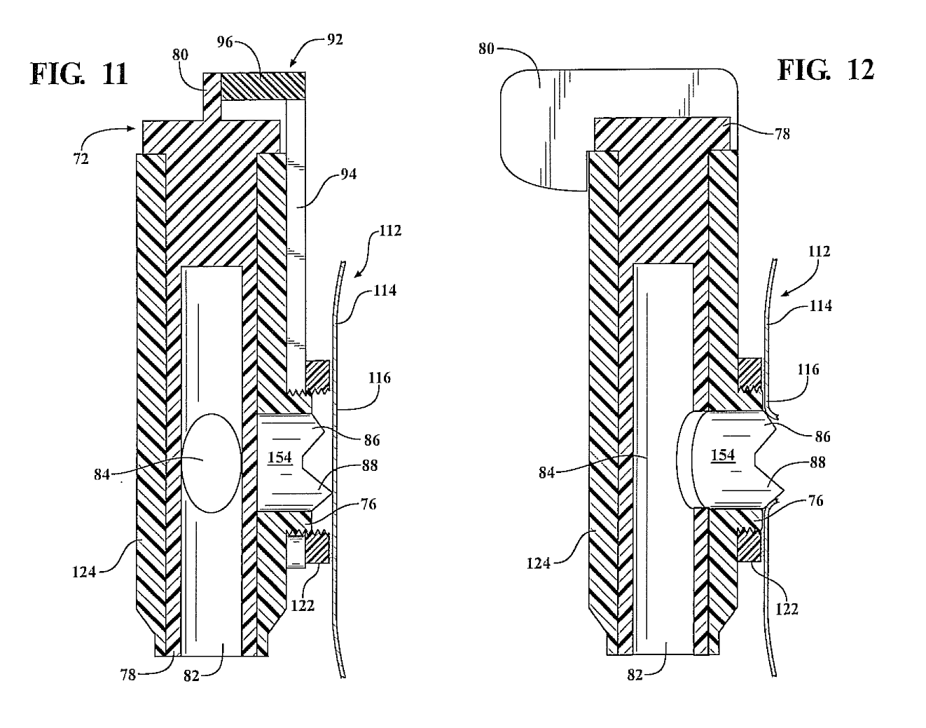

With reference now to FIGS. 10 and 11, the operation of the fitment assembly 10 of the second preferred embodiment is provided. In operation, the security device 90 is removed from the tap 72, and the seal 132 is removed from the base 122. The base 122 is placed firmly onto a desired location of the pouch 112 so as to place the adhesive coating 130 into contact with the pouch body 116, wherein the fitment assembly 110 is fixedly mounted thereto. The tube spout 124 is rotated along a first plane, indicated by “B”. As the tube spout 124 is rotated, the port 76 is displaced further into the base 122 so as to push the elongated piercing member 154 axially into the pouch 112. The elongated piercing member 54 engages the pouch 12, and the first portion 86 creates an opening in the pouch 112. As the tap 72 is rotated, the second portion 88 follows the first portion 86 further clearing the opening in the pouch 112 so as to facilitate the flow of fluids from the pouch 112 into the tap body 78.

The user may then rotate the handle 80 in a second plane, indicated by “A” so as to place the bore 84 into fluid communication with the port 76 thereby placing the fitment assembly 110 into the open position wherein fluid from the pouch 112 is accessible and may flow out through the opening of the tap 72, as shown in FIG. 11. Stopping fluids may simply be done by rotating the handle 80 so as to displace the bore 84 from fluid communication with the port 76, as shown in FIG. 10. Though the tap 72 is shown with a handle 80, it is anticipated that other devices such as a push button may be used to open and close the tap 72.

Obviously, many modifications and variations of the present invention are possible in light of the above teachings and may be practiced otherwise than as specifically described.

1. A fitment assembly for use with a pouch formed from a sheet of material, the fitment assembly comprising:
a base having an adhesive coating;
a tube spout fitment having a first passageway, the tube spout mounted to the base;
a cap rotatably mounted to the tube spout fitment, the cap having an elongated piercing member configured to be disposed within the tube spout fitment, wherein the adhesive surface of the base is selectively mounted onto the pouch, and the cap may be rotated so as to push the elongated piercing member into the pouch, puncturing the pouch and providing access to the contents of the pouch.

2. The fitment assembly as set forth in claim 1, further including a spacer, the spacer disposed between the cap and the base.

3. The fitment assembly as set forth in claim 1, further including a seal disposed on the adhesive coating, the seal protecting the adhesive coating.

4. The fitment assembly as set forth in claim 1, wherein the cap includes a threaded inner wall surface and the tube spout includes a threaded outer wall surface.

5. The fitment assembly as set forth in claim 1, wherein the elongated piercing member is a generally cylindrical member having a pointed end portion.

6. The fitment assembly as set forth in claim 2, wherein the cap includes a peripheral edge defining an opening, and a portion of the elongated piercing member extends beyond the peripheral edge of the cap.

7. The fitment assembly as set forth in claim 6, wherein the end portion includes a first piercing member spaced apart a second piercing member.

8. The fitment assembly as set forth in claim 7, wherein the first and second piercing member each have a walled surface and an angled surface so as to form a ramp shape, wherein the walled surface of the second piercing member is longer than the walled surface of the first piercing member.

9. The fitment assembly as set forth in claim 7, wherein the first and second piercing member are generally symmetrical to each other, the first and second piercing member extending outwardly from the distal end of the elongated piercing member, the first and second piercing member having an elongated body and a slanted edge at the distal end of the elongated body, wherein the first piercing member is longer than the second piercing member.

10. The fitment assembly as set forth in claim 1, further including a tap having a tap body and a handle, the tap body rotatably mounted within the first passageway of the tube spout, the tap body including a second passageway and a bore in fluid communication with the second passageway;
the tube spout rotatably mounted to the base, the tube spout fitment further including a port, the elongated piercing member mounted on the distal end of the port, the port rotatably mounted to the base, wherein the rotation of the tube spout fitment displaces the elongated piercing member into contact with the pouch body so as to puncture the pouch, and the handle is operable to rotate the tap body within the tube spout so as to place the bore in communication with the port to provide access to the contents of the pouch.

11. The fitment assembly as set forth in claim 10, wherein the port includes a threaded outer surface, the base includes a threaded inner wall surface, the threaded outer surface of the port configured to threadingly engage the threaded inner wall surface of the base.

12. The fitment assembly as set forth in claim 10, wherein the elongated piercing member includes a first portion and a second portion, the first and second portion being ramp shaped and disposed on the distal end of the elongated piercing member.

13. The fitment assembly as set forth in claim 12, wherein the first portion is longer than the second portion.

14. The fitment assembly as set forth in claim 10, further including a security device, the security device having a stop plate and a pair of arms, each arm spaced apart from the other and configured to engage the base, wherein the pair of arms are engaged with the base and the stop plate is placed in contact with the handle so as to prevent the handle from being turned when the fitment assembly is mounted on the pouch.
